(19) United States
(12) Patent Application Publication
(10) Pub. No.: US 2017/0211884 A1
(43) Pub. Date: Jul. 27, 2017

(54) NON-OXIDATION HEAT TREATMENT SYSTEM HAVING INTERNAL RX GAS GENERATOR

(71) Applicant: KOREA INSTITUTE OF ENERGY RESEARCH, Daejeon (KR)

(72) Inventors: Sang Keun DONG, Daejeon (KR); Je Bok YANG, Daejeon (KR); Woo Nam JUNG, Daejeon (KR)

(21) Appl. No.: 15/404,666

(22) Filed: Jan. 12, 2017

(30) Foreign Application Priority Data
Jan. 22, 2016 (KR) 10-2016-0008169

(51) Int. Cl. F27B 9/04; F27B 9/36; F27B 9/30; F27D 7/06; F27D 3/00

(52) U.S. Cl. CPC F27B 9/047; F27D 7/06; F27D 3/00; F27B 9/3044; F27B 9/36; F27D 2007/063; F27M 2003/01; F27M 2003/04; F27M 2003/05

(57) ABSTRACT

A non-oxidation heat treatment system having internal Rx gas (endothermic gas) generator includes: a heat treatment furnace whose internal environment kept to an atmosphere of an Rx gas; internal reformers for accommodating reaction catalysts for generating the Rx gas; material supply means for mixing raw gas as a material for generating the Rx gas and air to a given ratio to supply the mixture to the internal reformers; heating means disposed in the heat treatment furnace to heat an internal temperature of the heat treatment furnace to a temperature needed for annealing; and a controller disposed on the outside to control the internal temperature of the heat treatment furnace through the control of the ON/OFF and combustion loads of the of the heating means, wherein the internal reformers are loaded to the interior of the heat treatment furnace and the heating means includes regenerative type radiant tube burners.

### CROSS-REFERENCE TO RELATED APPLICATION

This application claims priority to Korean Patent Application No. 10-2016-0008169, filed on Jan. 22, 2016, the disclosure of which is incorporated herein by reference in its entirety.

### BACKGROUND OF THE INVENTION

1. Field of the Invention

The present invention relates to a heat treatment system for an object to be heat-treated in an atmosphere of an endothermic gas (hereinafter, referred to as ‘Rx gas’), and more particularly, to a non-oxidation heat treatment system that has an Rx gas generator embedded in a heat treatment furnace.

2. Description of Related Art

High-level heat treatment products, which are used for automobile components and electronic components made of steel, SUS, copper alloy, and so on, are subjected to heat treatment like annealing, sintering, and brazing in a non-oxidation atmosphere, that is, H2 and CO atmospheres. The atmospheric gas for building the non-oxidation atmosphere is generated through low excess air combustion, that is, through the combustion in a state of fuel rich, and then introduced into a heat treatment furnace.

The atmospheric gas, which is used for general heat treatment like annealing, sintering, brazing, carburizing, and so on, generally makes use of an Rx gas. In more detail, the Rx gas is gas which is produced by adding an appropriate amount of air to a raw gas and converting the added material in a catalytic reactor kept to a high temperature (about 1000° C.), so that the Rx gas is used for heat treatment like annealing, sintering, brazing, carburizing, and so on.

FIG. 1 is a schematic side view showing a conventional heat treatment system.

As shown in FIG. 1, the Rx gas used for the heat treatment in the conventional heat treatment system is generated and supplied from an Rx gas generator 100 disposed at the outside of the heat treatment system. That is, most of the conventional heat treatment system is provided with the Rx gas generator 100 which is disposed at the outside of a furnace 300 in such a manner as to introduce the Rx gas generated therefrom into a closed treatment space of the interior of the furnace 300 through a pipe.

Since atmospheric gases, H2, CO, and CO2 exist in a balanced way, the remaining gases are controlled at the same time through the control of CO2, and through the control of CO2, accordingly, the Rx gas generator 100 controls a reduction heat treatment atmosphere. For such control, the Rx gas generator 100 has to operate cooperatively with a CO2 controller 200, so that the size of the Rx gas generator 100 becomes bulky, which makes the Rx gas generator 100 disposed at the outside of the furnace 300.

Accordingly, the conventional heat treatment system needs a high building cost, and further, as it is large in volume, it requires a substantially large installation space, thereby undesirably having limitations in the application environment thereof. Moreover, the maintenance for the furnace 300 and the Rx gas generator 100 at which heat treatment is actually carried out and the CO2 controller 200 should be additionally carried out, thereby undesirably having difficulties in the maintenance of the whole system.

In addition, most of the conventional heat treatment system makes use of an electric heater 400 as a heat source for building a temperature environment adequate for the heat treatment. The electric heater 400 is accurately and rapidly accessible to treatment temperatures varied according to products, thereby being advantageous to the temperature control, but makes use of electricity having high energy production cost, thereby being disadvantageous in view of environment and economical effects.

Further, in case of the external Rx gas generator 100 as shown in FIG. 1, a heat source is additionally needed to allow an internal temperature of a catalytic reactor to be under an atmosphere of a high temperature (about 1000° C.). That is, the heat source, for example, a burner is separately disposed from the heater 400 disposed in the heat treatment furnace, which undesirably causes a high manufacturing cost and a bad energy efficiency.

### SUMMARY OF THE INVENTION

Accordingly, the present invention has been made in view of the above-mentioned problems occurring in the prior art, and it is an object of the present invention to provide a non-oxidation heat treatment system that is provided with an Rx gas generator embedded in a heat treatment furnace, thereby achieving the compactness and miniaturization in volume.

It is another object of the present invention to provide a non-oxidation heat treatment system that is provided with an Rx gas generator embedded in a heat treatment furnace, so that a burner for building an atmosphere of a high temperature (about 1000° C.) for catalyst reaction is not used at all.

It is yet another object of the present invention to provide a non-oxidation heat treatment system having an Rx gas generator embedded in a heat treatment furnace that makes use of regenerative type radiant tube burners as heating means in the heat treatment furnace, instead of an electric heater, thereby achieving eco-friendly and energy saving effects.

To accomplish the above-mentioned objects, according to the present invention, there is provided a non-oxidation heat treatment system having an internal Rx gas (endothermic gas) generator, including: a heat treatment furnace whose internal environment kept to an atmosphere of an Rx gas; internal reformers for accommodating reaction catalysts for generating the Rx gas; material supply means for mixing raw gas as a material for generating the Rx gas and air to a given ratio to supply the mixture to the internal reformers; heating means disposed in the heat treatment furnace to heat an internal temperature of the heat treatment furnace to a temperature needed for annealing; and a controller disposed on the outside to control the internal temperature of the heat treatment furnace through the control of the ON/OFF and combustion loads of the of the heating means, wherein the internal reformers are loaded to the interior of the heat treatment furnace and the heating means includes regenerative type radiant tube burners.

According to the present invention, desirably, each internal reformer includes: a catalyst reaction part having a bar-shaped tube capable of allowing the mixture of the raw gas and air to flow therealong, reforming catalysts put in the intermediate portion of the tube, and ceramic fibers sealedly inserted into the inlet; and a header part adapted to introduce the mixture into the inlet of the catalyst reaction part.

According to the present invention, desirably, the reforming catalysts are pellet type catalysts formed by supporting ruthenium or nickel in alumina or silica media.

According to the present invention, desirably, the header part has a flange disposed unitarily thereto, the flange having a larger diameter than the catalyst reaction part.

According to the present invention, desirably, the material supply means includes: a raw gas accommodation part for accommodating the raw gas therein; a blower for mixing air to the raw gas supplied from the raw gas accommodation part to supply the mixture to the internal reformers; and an electronic valve located between the raw gas accommodation part and the blower to adjust an air-fuel ratio (the ratio of air to raw gas) through the control of the flow rate of raw gas.

According to the present invention, desirably, each regenerative type radiant tube burner includes: a burner part; a heat storage part for storing the heat contained in the exhaust gas generated upon the combustion operation of the burner part to make use of the stored heat to preheat the sucked air for combustion; and a conversion part for controlling alternate introduction of the sucked air and exhaust gas into the heat storage part.

According to the present invention, desirably, the non-oxidation heat treatment system further includes: a first nitrogen chamber formed in the inlet of the heat treatment furnace into which the object to be heat-treated is loaded; a second nitrogen chamber formed in the outlet of the heat treatment furnace from which the heat-treated object is discharged; and nitrogen gas supply means for supplying the nitrogen gas to the first nitrogen chamber and the second nitrogen chamber.

According to the present invention, desirably, the regenerative type radiant tube burners are disposed spaced apart from each other by a given distance above and under a conveyor belt located in the interior of the heat treatment furnace, the conveyor belt being adapted to move the object to be heat-treated therealong in such a manner as to allow the object to be heat-treated to be exposed to the Rx gas atmosphere built by the heat treatment furnace.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic side view showing a conventional heat treatment system;

FIG. 2 is a schematic side view showing a non-oxidation heat treatment system having an Rx gas generator embedded in a heat treatment furnace according to the present invention;

FIGS. 3 and 4 are side and plan views showing the detailed configuration of the internal components of a heat treatment furnace of FIG. 2;

FIG. 5 is a side view showing each internal reformer adopted in the heat treatment furnace of FIG. 2;

FIG. 6 is a schematic view showing a configuration of material supply means for supplying a material made by mixing raw gas and air to the internal reformer of FIG. 5;

FIG. 7 is a side view showing each regenerative type radiant tube burner adopted in the heat treatment furnace of FIGS. 2 to 3;

FIG. 8 is a cross-sectional view showing a conversion part of the regenerative type radiant tube burner of FIG. 7; and

FIG. 9 is a sectional view showing an example in which the regenerative type radiant tube burners are mounted in the heat treatment furnace.

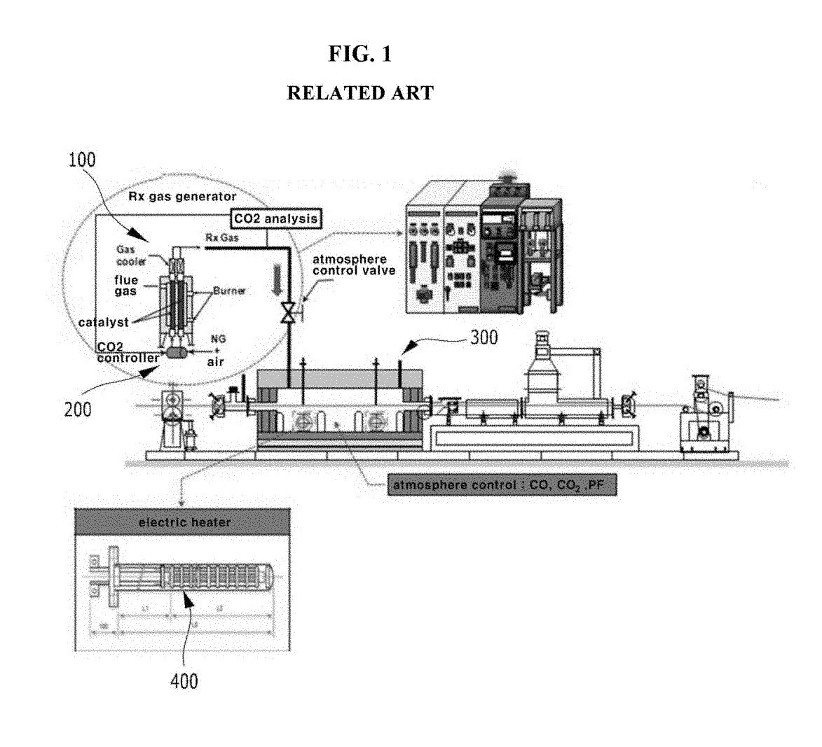

### DETAILED DESCRIPTION OF THE PREFERRED EMBODIMENTS

Hereinafter, the present invention is in detail disclosed with reference to the attached drawings.

Before the present invention is disclosed and described, the terminology used herein is for the purpose of describing particular embodiments only and is not intended to be limiting. The term ‘a’ or ‘an’, as used herein, is defining as one or more than one.

The term ‘including’ and/or ‘having’, as used herein are intended to refer to the above features, numbers, steps, operations, elements, parts or combinations, and it is to be understood that the terms are not intended to preclude the presence of one or more features, numbers, steps, operations, elements, parts or combinations and added possibilities.

Terms, such as the first, and the second, may be used to describe various elements, but the elements should not be restricted by the terms. The terms are used to only distinguish one element from the other element.

Terms, such as ‘part’, ‘unit’, and ‘module’, as used herein may be used to describe a unit for treating at least one function or operation, and the function or operation may be carried out by hardware, software, or a combination of hardware and software.

The present invention is disclosed with reference to the attached drawings wherein the corresponding parts in the embodiments of the present invention are indicated by corresponding reference numerals and the repeated explanation on the corresponding parts will be avoided. If it is determined that the detailed explanation on the well known technology related to the present invention makes the scope of the present invention not clear, the explanation will be avoided for the brevity of the description.

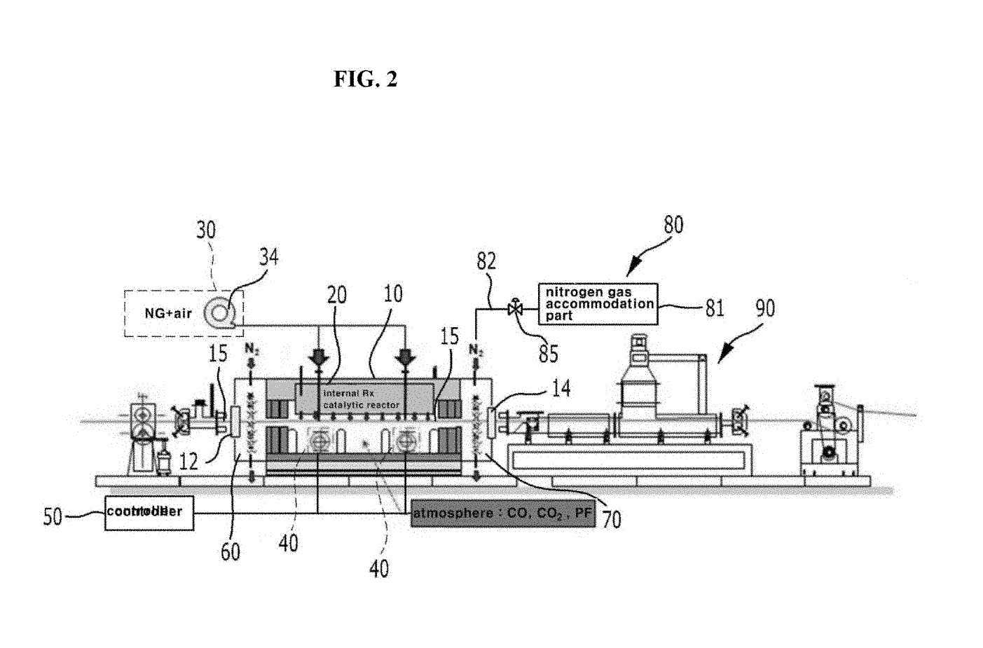

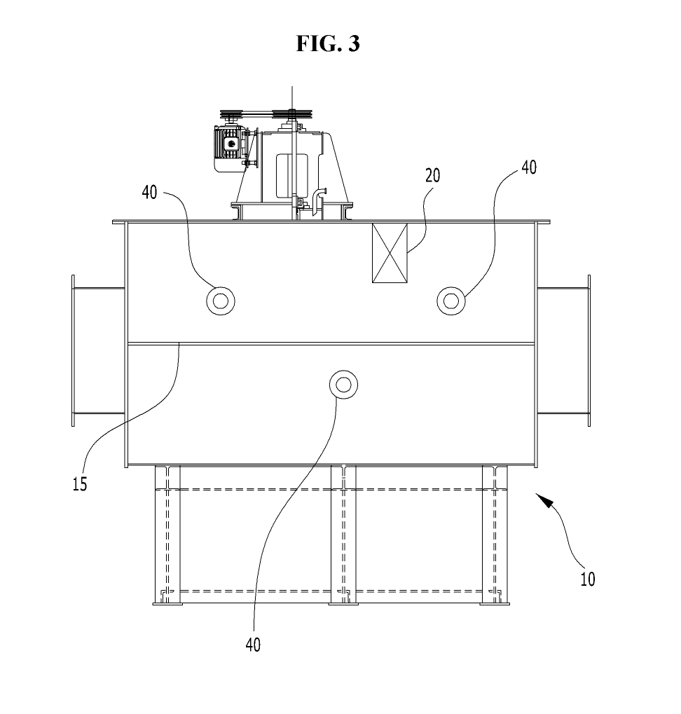

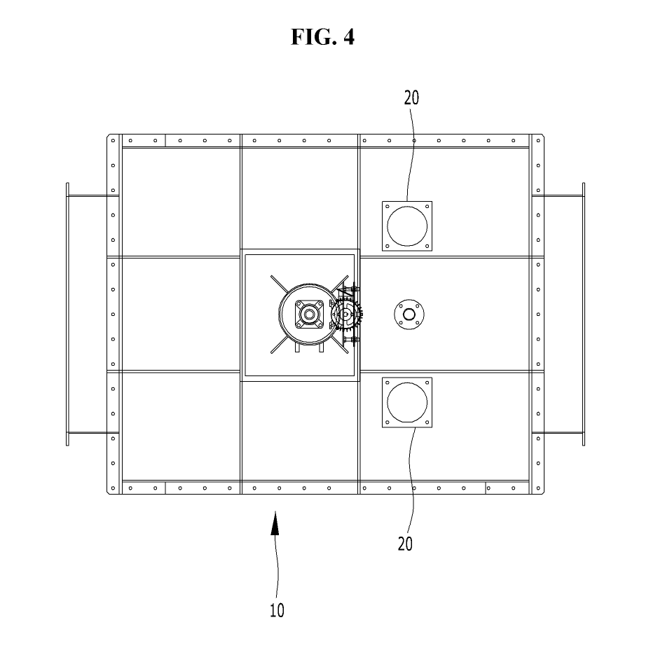

FIG. 2 is a schematic side view showing a non-oxidation heat treatment system having an Rx gas generator embedded in a heat treatment furnace according to the present invention, and FIGS. 3 and 4 are side and plan views showing the detailed configuration of the internal components of a heat treatment furnace of FIG. 2.

As shown in FIGS. 2 to 4, a non-oxidation heat treatment system having an Rx gas generator embedded in a heat treatment furnace according to the present invention includes the heat treatment furnace 10 in which an internal environment is maintained in an Rx gas atmosphere. The heat treatment furnace 10 has an inlet 12 formed on one side thereof to introduce an object to be heat-treated thereinto, an outlet 14 formed on the other side thereof to discharge the heat-treated object therefrom, and a given heat treatment space surrounded with a fire resisting material.

The heat treatment furnace 10 is not defined particularly because the size or shape thereof is differently designed in accordance with the material of the object to be heat-treated, the number of objects, and space environments in which the system is built, and so as to build a non-oxidation Rx gas atmosphere in the heat treatment space, internal reformers 20, in which reaction catalysts for generating an Rx gas are accommodated, are loaded from the exterior of the heat treatment furnace 10 to the interior of the heat treatment furnace 10 in such a manner as to allow a portion thereof to be located at the outside of the heat treatment furnace 10.

A mixture (which is a mixed material made by mixing a raw gas and air to a given ratio) as a material for generating the Rx gas is supplied to each internal reformer 20 from material supply means 30. The material supply means 30 mixes the raw gas and air to the given ratio at the outside of the heat treatment furnace 10 and supplies the mixture to each internal reformer 20 to build the Rx gas atmosphere corresponding to the treatment environments varied according to the materials of the object to be heat-treated.

A temperature in the internal space of the heat treatment furnace 10 is kept to a temperature needed for heat treatment, for example, annealing, through heating means 40, and at this time, a plurality of regenerative type single radiant tube burners 40 (hereinafter, referred to as ‘regenerative type RT burner’) as the heating means 40 is used. Each of the regenerative type RT burners 40 makes use of fuel gas, temporarily stores combustion heat, and preheats sucked air for combustion with the stored combustion heat, thereby greatly improving the heat efficiency.

The regenerative type RT burners 40 operate under the control of a controller 50 having a given control logic. Under the control of the controller 50, that is, the regenerative type RT burners 40 build the interior of the heat treatment furnace 10 to the temperature environment adequate for the heat treatments varied according to the materials of the object to be heat-treated. At this time, the controller 50 controls heat generation rates through the control of the ON/OFF and combustion loads of the regenerative type RT burners 40 to adjust the internal temperature of the heat treatment furnace 10.

The regenerative type RT burners 40 are disposed spaced apart from each other by a given distance above and under a conveyor belt 15 located in the interior of the heat treatment furnace 10 in such a manner as to allow the object to be heat-treated to be exposed to the Rx gas atmosphere built by the heat treatment furnace 10, and at this time, the controller 50 includes automatic ignition control logics and combustion load control logics for the respective regenerative type RT burners 40 corresponding to the conveying speeds of the object to be heat-treated, thereby controlling the on/off of the respective regenerative type RT burners 40 to control the whole combustion load of the regenerative type RT burners 40.

Further, a first nitrogen chamber 60 is formed in the inlet 12 of the heat treatment furnace 10 into which the object to be heat-treated is loaded. Also, a second nitrogen chamber 70 is formed in the outlet 14 of the heat treatment furnace 10 from which the heat-treated object is discharged. A nitrogen gas is continuously supplied from the outside to the interiors of the first nitrogen chamber 60 and the second nitrogen chamber 60 so that the internal environment of the heat treatment furnace 10 can be built in the non-oxidation atmosphere.

Unlike the conventional practice wherein only Rx gas as the converted gas is used, the nitrogen gas is used to build the heat treatment environment to the non-oxidation atmosphere, thereby substantially reducing the amount of Rx gas used, fuel costs and the number of processes, avoiding air pollution problems, and improving work place environments. Further, negative pressures on the inlet 12 and the outlet 14 of the heat treatment furnace 10 are suppressed to the maximum, thereby reducing explosion risks.

Nitrogen gas supply means 80, which is located at the outside of the heat treatment furnace 10, supplies the nitrogen gas to the first nitrogen chamber 60 and the second nitrogen chamber 70. The nitrogen gas supply means 80 includes a nitrogen gas accommodation part 81 for accommodating the nitrogen gas therein and a nitrogen gas supply pipe 82 connecting the nitrogen gas accommodation part 81 to the first nitrogen chamber 60 and the second nitrogen chamber 70 to supply the nitrogen gas accommodated in the nitrogen gas accommodation part 81 to the first nitrogen chamber 60 and the second nitrogen chamber 70.

The nitrogen gas accommodation part 81 is a container in which the nitrogen gas supplied from the outside is filled and stored, and otherwise, it may be provided to the form of a nitrogen gas generator from which pure nitrogen gas is generated. Further, the nitrogen gas supply means 80 includes a nitrogen gas supply control valve 85 mounted on the intermediate portion of the nitrogen gas supply pipe 82 to admit or stop the supply of nitrogen gas under the control of a separate controller.

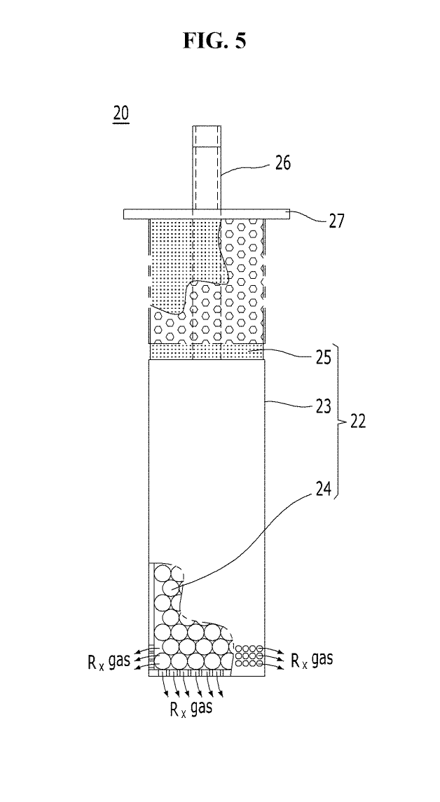

FIG. 5 is a side view showing each internal reformer adopted in the heat treatment furnace of FIG. 2.

As shown in FIG. 5, each internal reformer 20, which is loaded into the heat treatment furnace 10, includes a catalyst reaction part 22 having a bar-shaped tube 23 capable of allowing the mixture of the raw gas and air to flow therealong, reforming catalysts 24 put in the intermediate portion of the tube 23, and ceramic fibers 25 sealedly inserted into the inlet 12, and a header part 26 adapted to introduce the mixture into the inlet 12 of the catalyst reaction part 22.

The reforming catalysts 24 of the catalyst reaction part 22 are pellet type catalysts formed by supporting ruthenium or nickel in alumina or silica media, and the header part 26 has a flange 27 attachedly fixed to the outer wall surface of the heat treatment furnace 10 in such a manner as to have a larger diameter than the catalyst reaction part 22, so that the catalyst reaction part 22 and the header part 26 are located correspondingly on the inside and outside of the heat treatment furnace 10.

The catalyst reaction part 22 of each internal reformer 20 is located on the inside of the heat treatment furnace 10 and maintained to a high temperature, and if the raw gas and the appropriate amount of air are applied to the catalyst reaction part 22 through the material supply means 30, the conversion through the reforming catalysts 24 occurs to allow the raw gas ingredients to be changed appropriately for heat treatment. That is, the gas atmosphere adequate for heat treatment is built through the reforming of the raw gas by the heat and catalysts.

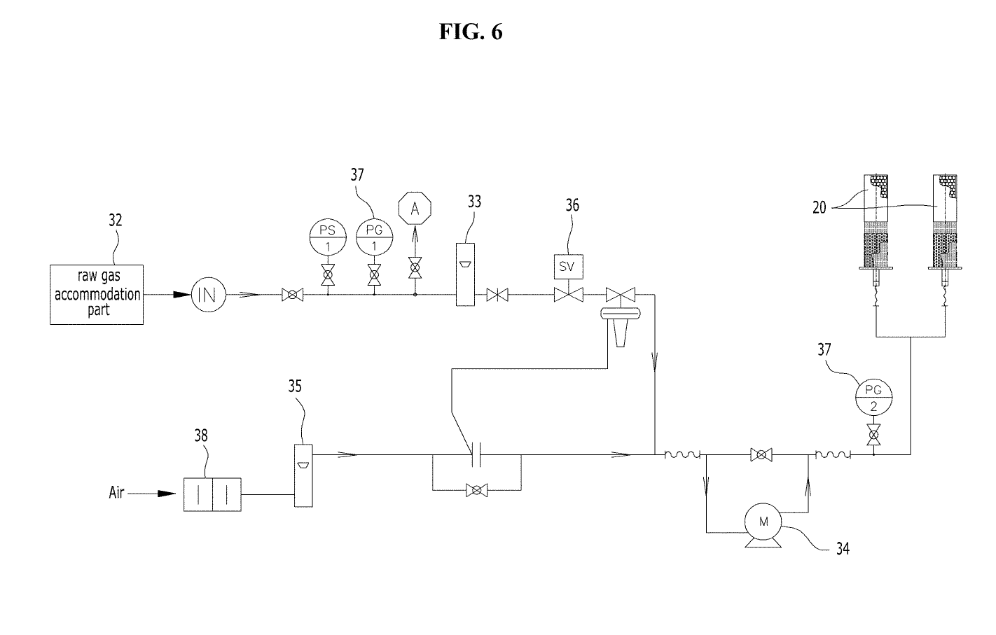

FIG. 6 is a schematic view showing a configuration of the material supply means for supplying a material made by mixing raw gas and air to the internal reformer of FIG. 5.

Referring to FIG. 6, the material supply means 30 includes a raw gas accommodation part 32 for accommodating the raw gas therein, a blower 34 for mixing air to the raw gas supplied from the raw gas accommodation part 32 to supply the mixture to the internal reformers 20, and an electronic valve 36 located between the raw gas accommodation part 32 and the blower 34 to adjust an air-fuel ratio (the ratio of air to raw gas) through the control of the flow rate of raw gas.

The raw gas filled in the raw gas accommodation part 32 is an LNG having hydrocarbon as a main ingredient, but it is not limited thereto. That is, the raw gas may include vapor or liquid hydrocarbon like LPG, naphtha, gasoline, kerosene and so on, and in consideration of resource recycling or economical effects, further, the raw gas may include a methane (CH₄) gas generated from the treatment process of sewage/waste water or food waste.

Reference numerals 33 and 35 in FIG. 6 designate flow meters mounted on a raw gas supply line and an air supply line to measure the flow rates of the raw gas and air, and a reference numeral 37 designates a pressure gauge for measuring a pressure on the raw gas supply line. Further, a reference numeral 38 designates an air filter located on an air inlet of the air supply line to filter foreign matters from the air introduced from the outside.

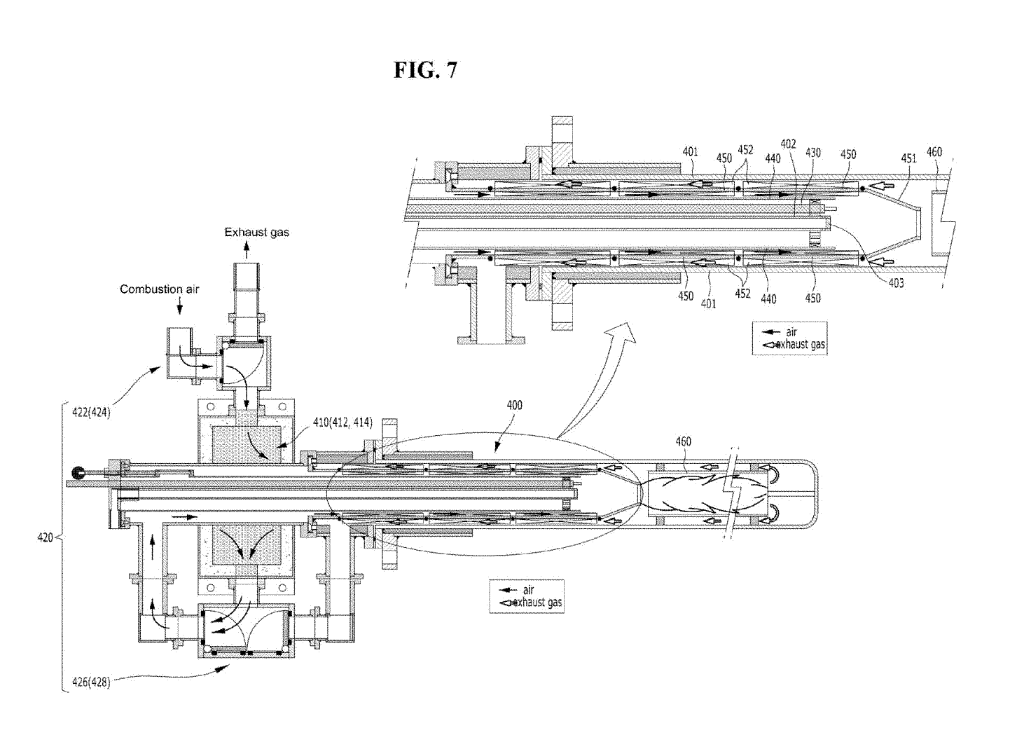

FIG. 7 is a side view showing each regenerative type RT burner adopted in the heat treatment furnace of FIGS. 2 to 3, and FIG. 8 is a cross-sectional view showing a conversion part of the regenerative type RT burner of FIG. 7.

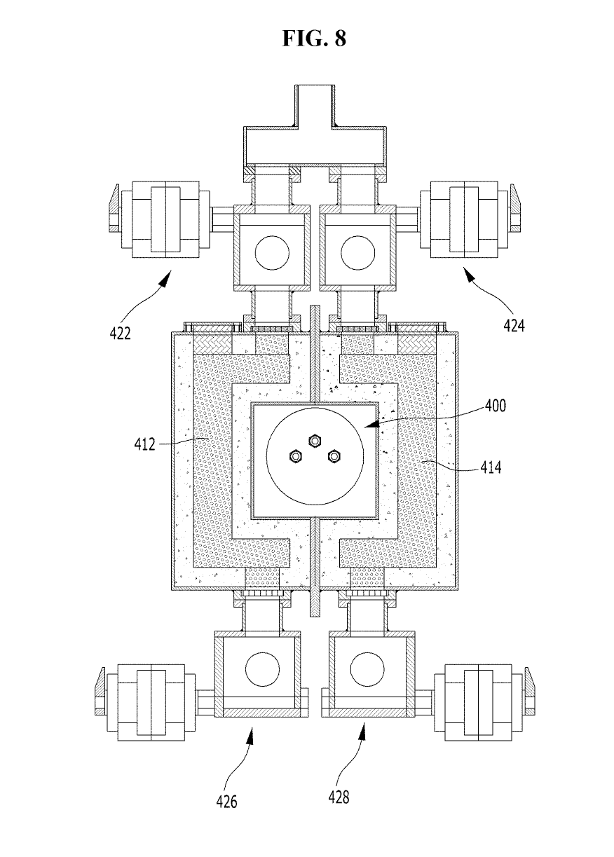

Referring to FIGS. 7 and 8, each regenerative type RT burner 40 includes a burner part 400, a heat storage part 410 for temporarily storing the heat contained in the exhaust gas generated upon the combustion operation of the burner part 400 to make use of the stored heat to preheat the sucked air for combustion, and a conversion part 420 for controlling alternate introduction of the sucked air and exhaust gas into the heat storage part 410 to allow the heat storage part 410 to conduct a heat exchanging operation.

The burner part 400 includes a burner body 401 in which combustion is generated and a gas introduction pipe 402 having a plurality of gas nozzle holes 403 formed on the end thereof. Further, the burner part 400 includes an ignition rod 430 disposed above the gas introduction pipe 402 in the longitudinal direction thereof to ignite the burner 40, and the gas introduction pipe 402 and the ignition rod 430 are accommodated in a cylindrical combustion air supply pipe 440.

The sucked air preheated to a given temperature through the heat storage part 410 and a portion of the recycled exhaust gas are supplied as the combustion air through the combustion air supply pipe 440 in which the gas introduction pipe 402 and the ignition rod 430 are accommodated, and the sucked air preheated to the given temperature and the exhaust gas are supplied to a pilot light attached to the end of the gas introduction pipe 402, thereby achieving non-flame combustion with little temperature deviation.

The combustion air supply pipe 440 is accommodated in a heat exchanger pipe 450, and the heat exchanger pipe 450 has a combustion nozzle 451 disposed on the end thereof. A plurality of heat exchanger fins 452 is arranged in a circumferential direction between the heat exchanger pipe 450 and the combustion air supply pipe 440, and through the heat exchanging operation with the exhaust gas by means of the heat exchanger fins 452, the sucked air for combustion flowing along the outer peripheral surface of the combustion air supply pipe 440 is preheated.

When the combustion reaction is generated from the burner part 400, in more detail, the exhaust gas generated from a tube 460 flows in directions of arrows as shown and passes through the heat exchanger fins 452. Through the heat conduction, at this time, the sucked air for combustion flowing between the combustion air supply pipe 440 and the heat exchanger pipe 450 is preheated, so that waste heat is sufficiently utilized to preheat the combustion air, thereby enhancing the energy efficiency.

The heat storage part 410 is divided into a first heat storage chamber 412 and a second heat storage chamber 414. The first heat storage chamber 412 and the second heat storage chamber 414 are opposed to each other to surround the burner part 400, while placing the burner part 400 therebetween, in such a manner as to be separated from each other to have the respective independent flow paths. Also, the first heat storage chamber 412 and the second heat storage chamber 414 are filled with porous heat storage materials made of stone or metals to store heat therein.

The heat storage part 410 alternately provides the moving paths of the exhaust gas and the sucked air, and accordingly, the energy of the exhaust gas stored in the heat storage part 410 is supplied to the burner part 400 again. The movements of the sucked air and the exhaust gas are controlled by the conversion part 420, and the conversion part 420 alternately controls intake and exhaust so that the intake and exhaust processes of the burner part 400 are at the same time carried out to achieve pull time combustion.

The conversion part 420 includes: a first converter 422 and a second converter 424 for introducing the sucked air for combustion into the first heat storage chamber 412 and the second heat storage chamber 414 or for controlling the discharge of the exhaust gas passing through the first heat storage chamber 412 and the second heat storage chamber 414 to the outside; and a third converter 426 and a fourth converter 428 for introducing the exhaust gas into the first heat storage chamber 412 and the second heat storage chamber 414 or for controlling the supply of the preheated sucked air passing through the first heat storage chamber 412 and the second heat storage chamber 414 to the burner part 400.

Each of the first to fourth converters 422, 424, 426 and 428 includes a valve for selectively blocking flow paths branched in the interior thereof to change the direction of the flow path and an actuator, for example, a hydraulic/pneumatic cylinder or motor disposed correspondingly to the valve. Through the flow path conversion of each converter, accordingly, the first heat storage chamber 412 and the second heat storage chamber 414 are alternately converted into intake and exhaust sides.

If the first heat storage chamber 412 is at the intake side, the second heat storage chamber 414 becomes at the exhaust side, and after a given period of time elapses, if the first heat storage chamber 412 becomes at the exhaust side by means of the conversion part 420, the second heat storage chamber 414 located at the opposite side to the first heat storage chamber 412 becomes at the intake side. Upon the conversion into the exhaust side, the heat energy of the exhaust gas is stored and transferred to the sucked air after conversion to the intake side, so that the sucked air is preheated to the given temperature and then supplied to the burner part 400.

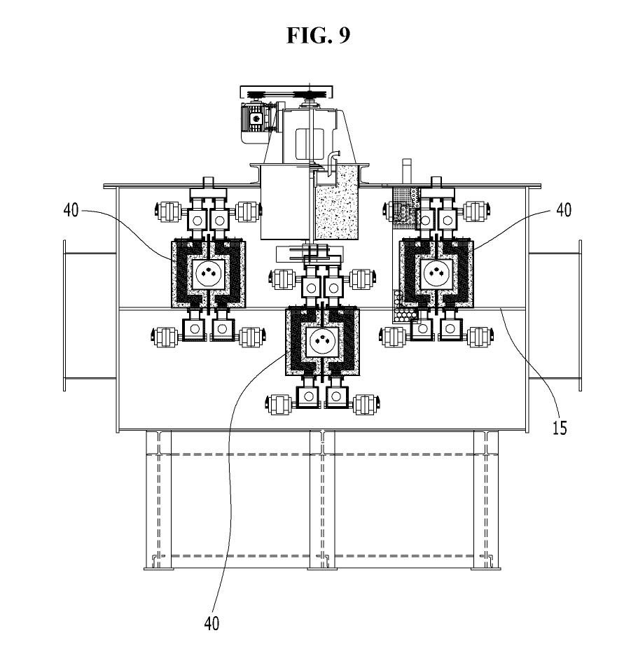

FIG. 9 is a sectional view showing an example in which the regenerative type RT burners are mounted in the heat treatment furnace.

As shown in FIG. 9, the regenerative type RT burners 40 are disposed spaced apart from each other by the given distance above and under the conveyor belt 15, and the conveyor belt 15 is adapted to move the object to be heat-treated therealong therealong in such a manner as to allow the object to be heat-treated to be exposed to the internal environment of the heat treatment furnace 10. As shown, desirably, the regenerative type RT burners 40 are disposed alternately above and under the conveyor belt 15, while being adjacent to the conveyor belt 15.

Hereinafter, the heat treatment process for the object to be heat-treated through the heat treatment system according to the present invention will be briefly explained in association with the operation of the heat treatment system.

Referring to FIG. 2, the object to be heat-treated is moved to the interior of the heat treatment furnace 10 along the conveyor belt 15. Doors (with no reference numerals) are disposed on the inlet 12 and the outlet 14 of the heat treatment furnace 10, and they have inner walls made of a fire resistant material, so that the heat treatment is conducted in a closed environment. At this time, the doors are open automatically or manually when the object is loaded or discharged.

When the object to be heat-treated is moved in the heat treatment furnace 19, the nitrogen gas is supplied at the same time to the first nitrogen chamber 60, so that the interior of the heat treatment furnace 10 is built to the non-oxidation atmosphere and the object to be heat-treated is further exposed to the nitrogen gas to allow the surface thereof to be naturally cleaned. If the object to be heat-treated is located at a given process position in the interior of the heat treatment furnace 10, the doors are closed, thereby building the closed heat treatment environment.

The regenerative type RT burners 40 are operated under the control of the controller 50 before the loading of the object to be heat-treated, and accordingly, the interior of the heat treatment furnace 10 is heated to the temperature adequate for heat treatment. Further, the mixture (the raw gas and air mixed to a given ratio) supplied from the raw material supply means 30 is modified by means of the reforming catalysts of the internal reformer 20 to generate the Rx gas, so that the interior of the heat treatment furnace 10 is kept to the high temperature Rx gas atmosphere.

Carburizing and tissue metamorphosis occur on the object through the heat treatment in the high temperature environment kept to the Rx gas atmosphere, thereby compensating for the mechanical properties thereof, and if the heat treatment for a given period of time is completed, the outlet 14 from which the object is discharged is open so that the object is moved to a post treatment device 90 along the conveyor belt 15. At this time, the heat-treated object is exposed to the nitrogen gas, while passing through the second nitrogen chamber 70, in such a manner as to allow the surface thereof to be naturally cleaned.

As set forth in the foregoing, the non-oxidation heat treatment system according to the present invention has the Rx gas generator embedded in the heat treatment furnace, thereby minimizing the whole heat treatment system, and suppresses decarburization and oxidation reaction for the object to be heat-treated in an N2 atmosphere, thereby reducing the amount of Rx gas used to the maximum to expect the reduction of the number of processes and fuel cost.

Moreover, the non-oxidation heat treatment system according to the present invention has the Rx gas generator embedded in the heat treatment furnace, so that the temperature of the Rx gas generator can be built to an atmosphere of a high temperature (about 1000° C.) for catalyst reaction, without having any separate burner used in the conventional practice, thereby achieving a low manufacturing cost and a high energy efficiency.

In addition, the non-oxidation heat treatment system according to the present invention makes use of the regenerative type radiant tube burners as heating means in the heat treatment furnace, instead of an electric heater used generally in the conventional practice, thereby building eco-friendly system capable of reducing the amount of electricity consumed to the maximum and further providing energy and operating cost saving effects.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A non-oxidation heat treatment system having an internal Rx gas (endothermic gas) generator, the system comprising:
a heat treatment furnace whose internal environment kept to an atmosphere of an Rx gas;
internal reformers for accommodating reaction catalysts for generating the Rx gas;
material supply means for mixing raw gas as a material for generating the Rx gas and air to a given ratio to supply the mixture to the internal reformers;
heating means disposed in the heat treatment furnace to heat an internal temperature of the heat treatment furnace to a temperature needed for annealing; and
a controller disposed on the outside to control the internal temperature of the heat treatment furnace through the control of the ON/OFF and combustion loads of the of the heating means,
wherein the internal reformers are loaded to the interior of the heat treatment furnace and the heating means includes regenerative type radiant tube burners.

2. The non-oxidation heat treatment system according to claim 1, wherein each internal reformer comprises:
a catalyst reaction part having a bar-shaped tube capable of allowing the mixture of the raw gas and air to flow therealong, reforming catalysts put in the intermediate portion of the tube, and ceramic fibers sealedly inserted into the inlet; and
a header part adapted to introduce the mixture into the inlet of the catalyst reaction part.

3. The non-oxidation heat treatment system according to claim 2, wherein the reforming catalysts are pellet type catalysts formed by supporting ruthenium or nickel in alumina or silica media.

4. The non-oxidation heat treatment system according to claim 2, wherein the header part has a flange disposed unitarily thereto, the flange having a larger diameter than the catalyst reaction part.

5. The non-oxidation heat treatment system according to claim 1, wherein the material supply means comprises:
a raw gas accommodation part for accommodating the raw gas therein;
a blower for mixing air to the raw gas supplied from the raw gas accommodation part to supply the mixture to the internal reformers; and
an electronic valve located between the raw gas accommodation part and the blower to adjust an air-fuel ratio (the ratio of air to raw gas) through the control of the flow rate of raw gas.

6. The non-oxidation heat treatment system according to claim 1, wherein each regenerative type radiant tube burner comprises:
a burner part;
a heat storage part for storing the heat contained in the exhaust gas generated upon the combustion operation of the burner part to make use of the stored heat to preheat the sucked air for combustion; and
a conversion part for controlling alternate introduction of the sucked air and exhaust gas into the heat storage part.

7. The non-oxidation heat treatment system according to claim 1, further comprising:
a first nitrogen chamber formed in the inlet of the heat treatment furnace into which the object to be heat-treated is loaded;
a second nitrogen chamber formed in the outlet of the heat treatment furnace from which the heat-treated object is discharged; and
nitrogen gas supply means for supplying the nitrogen gas to the first nitrogen chamber and the second nitrogen chamber.

8. The non-oxidation heat treatment system according to claim 1, wherein the regenerative type radiant tube burners are disposed spaced apart from each other by a given distance above and under a conveyor belt located in the interior of the heat treatment furnace, the conveyor belt being adapted to move the object to be heat-treated therealong in such a manner as to allow the object to be heat-treated to be exposed to the Rx gas atmosphere built by the heat treatment furnace.
